(19) United States
(12) Patent Application Publication
(10) Pub. No.: US 2005/0091316 A1
(43) Pub. Date: Apr. 28, 2005

(54) System and method for creating and selectively sharing data elements in a peer-to-peer network

(76) Inventors: Oscar Ponce, Oakton, VA (US); Ivan Aguilar, Oakton, VA (US); Manuel Martin, Oakton, VA (US)

Correspondence Address: MINTZ LEVIN COHN FERRIS GLOVSKY AND POPEO PC, 12010 SUNSET HILLS ROAD, SUITE 900, RESTON, VA, 20190, US

(21) Appl. No.: 10/677,387

(22) Filed: Oct. 3, 2003

(51) Int. Cl. G06F 15/16

(52) U.S. Cl. 709/205

(57) ABSTRACT

A system and method are provided for sharing information in a distributed peer-to-peer network wherein an information owner invites one or more trusted users to participate in information sharing and wherein the information owner designates permission levels for each of one or more trusted users. Upon accepting the invitation, the one or more trusted users may be granted with complete access, read only access, or blocked access to the shared information. The one or more trusted users may selectively decide to accept or decline to share information on a folder-to-folder basis. Any modifications made to the shared information may be disseminated to all the trusted users in real-time, upon log-in to a central server, or after a predetermined time delay.

### FIELD OF THE INVENTION

The invention is directed to a system and method for creating and selectively sharing data elements in a peer-to-peer network.

### BACKGROUND OF THE INVENTION

Widespread use of the Internet offers great potential for collaborative technologies, both as an enabling infrastructure and as a platform for integrating existing end-user applications. For example, the World Wide Web (WWW) may be employed by dispersed working-groups to jointly author, comment, and annotate shared information.

Technologies for collaboratively exchanging information among distributed work-groups include electronic mail (e-mail) programs and server-based portals. While e-mail programs enable users to send information to one or more other users, various drawbacks exist.

For example, e-mail programs provide little support for sharing changes to content after an initial e-mail message is sent. Rather, the sender must send a new e-mail message to recipients every time changes are made to the e-mail content, including any changes made to attachments associated with the e-mail message. As a result, recipients receive both the previously sent e-mail message and the updated e-mail message as separate messages for review. Other drawbacks exist.

Another technology for collaboratively exchanging and sharing information among distributed work-groups may include using centralized servers that have shared workspaces for providing common document storage and retrieval facilities. The shared workspaces may be implemented on the centralized servers and may be accessed from different platforms using standard WWW clients. Each shared workspace provides workspace members with access to shared information objects therein, which may include documents, links, and folders. Various drawbacks exist with these technologies.

For example, these approaches typically require a workspace administrator to establish privileges and control who has access to what information. This also requires, in some cases, someone to approve content that is posted to the workspace. In some cases, users must continuously check for new or changed content. In other cases, users get an email alerting them that changes have been made. This requires them to check their email for such notices, and then switch to another application (e.g., a browser) to access the server. Other drawbacks exist.

Peer-to-peer systems in general are known. In many cases, these systems enable a user to illegally share files created in one application (e.g., music files, videos or graphics). In many cases, such files are available to be shared with any user. The “owner” of the file typically cannot limit with whom the information is to be shared. In some cases, a user must create content using an application separate from the peer-to peer application. Various other drawbacks exist.

Other drawbacks exist with these and other known systems

### SUMMARY OF THE INVENTION

Various aspects of the invention overcome at least some of these and other drawbacks of existing systems. According to one embodiment, the system comprises a peer-to-peer based system architecture. The system comprises a number of peer terminals, each of which may be connected or connectable to one or more special purpose peers (e.g., via a wired, wireless, and/or combination of wired and wireless connection) and/or one or more networks (e.g., a wired network, a wireless network, a combination of wired and wireless networks or other networks). One or more peers may be connected to the special purpose peer. Also, one or more servers may be connected to the network.

The special purpose peer may include a routing peer, a back-up peer, an authentication peer, a presence peer, a relay peer, and/or other special purpose peers. In an exemplary embodiment, peer terminals may be configured as special purpose peers. The routing peer may serve as a gateway between peer terminals to provide, for example, indirect communication between two or more peer terminals when a direct connection between peer terminals may not be established. The back-up peer, for example, may store an identical copy of content associated with a selected peer terminal, may mirror changes made to the selected peer terminal in real-time, and/or may be available to synchronize (e.g., send and/or receive) information with the selected peer terminal. The authentication peer, for example, may check credentials of users and validate that users are registered users. The presence peer, for example, may maintain availability information about registered users. The relay peer, for example, may serve as a gateway between peer terminals and may temporarily store and retrieve selected messages when the target peer terminal is operating offline.

Each of the peer terminals preferably includes at least a processor, a memory, a display, and at least one input mechanism (e.g., keyboard or other input mechanism). Preferably, each peer terminal includes an e-mail program or the ability to access an email account via a network (e.g., the Internet). Other applications may reside on the peer terminal, as desired.

Each peer terminal is preferably capable of receiving an invitation to install software as described herein and/or is capable of directly installing the software without having to first receive an invitation. In either case, once the software is installed onto the peer terminal, the user may use the peer terminal to perform the functions described herein.

The software has various purposes. For convenience, each of the related sets of functions performed by the software will be referred to as modules. These modules may be part of a single program or a collection of related components that operate together. In some cases, not all modules will need to be used or are desired to be used. The software is purposefully designed to be flexible to permit modules to be added. Certain functions and features are enabled via peer side software that is loaded onto the peer terminals. Other functions and features are performed by software resident on the special purpose peers and/or server side software. In some cases, the peer side modules interact with the software resident on the special purpose peers and/or server software.

By way of example, the peer side software may include one or more of the following (and other) modules.

A user interface module may be provided to enable a user to interact with the application and to provide the display of various data elements and other information, tools and other options to the user.

A login module may be provided to enable a user to login. When the peer terminal is on-line, part of the login procedure may involve interaction with a login module on the special purpose peer and/or the server. When off-line, the peer side login module performs the login process.

An invitation module may be provided to enable a user to invite other participants to participate in peer-to-peer communications for a particular project, to share certain data elements or otherwise participate in peer-to-peer communications. An “Invitation” refers to a request from one user to another user to participate in some way. The invitation may be sent via email or otherwise. If the recipient of an invitation has the application software installed on the peer terminal, then the recipient may participate (or decline to do so). If the recipient does not have the application software installed on the peer terminal, the recipient may be prompted to install the application software in order to participate. Preferably, once a user is a registered user, any invitations to participate are done based on direct peer-to peer communication via the application, without the need for use of a separate email application.

A permission granting module may be provided to enable a user to selectively grant permissions to certain users for specified data elements or other information.

A synchronization module may be provided to automatically and/or instantaneously propagate changes made to data elements, wherein the changes may be propagated in essentially real-time. Peer terminals may propagate the changes to all or a select number of other peer terminals that are associated with users that have accepted an invitation from the information owner to share the data elements. In some cases, the synchronization is performed directly between peer terminals without intervention by the special purpose peer and/or the server. In other cases, the special purpose peer and/or the server may be involved in some aspects of the synchronization.

A memory module may be provided to store a local copy of the data elements on the peer terminal, to which a user has access and other information.

A contact creating module may be provided to enable a user to create and manage contacts. At least two types of contacts may be used. The first, simply referred to as a contact, may be a person, place, thing or other contact about which a user has information. A sharing contact, sometimes referred to as a “Friend,” may be a contact with which a user shares data elements. As detailed below, each user may have direct or indirect control over the contacts with which the user elects to share data elements and the data elements to be shared.

Contacts may be defined by contact information that may be segmented according to two or more categories of information. For example, the categories may include a first level of information and a second level of information. A first level may include “main” information such as one or more of a nickname, an e-mail address, a first name, a last name, comments, or other information. A second level may include “personal” information such as one or more of a street address, phone numbers, a facsimile number, a mobile number, a pager number, and other personal information. The segmentation of information into levels facilitates the ability to share only selected aspects of a contact's information with one or more users.

An integrated communications module (e.g., chat or other communications program) may be provided to enable the user to easily communicate with Friends via the application. Additionally, the communications may be saved and shared.

The “data elements” may include various types of data elements and other information. Each data element may include other data elements. According to one embodiment, the primary data elements may include one or more Folders, a Folder Hierarchy and one or more Items stored in each folder. By way of example, each Folder may relate to a project, a topic or something else. Other data elements may include Contacts and/or Friends. A Folder of contacts may include a group of related contacts.

The user interface module may enable a user to select a data element (e.g., a Folder) and cause the contents of that Folder to be displayed in a display area. The folder may contain a list of items, a list of contacts or other data elements.

According to one embodiment, the peer side software enables information owners to invite selected other users to participate in the peer-to-peer communication and to share selected data elements or other information. By accepting the invitation, the selected other users may become a Friend with whom data elements or other information may be selectively shared.

According to one aspect of the invention, when a user logs in and is operating online, the user is authenticated; any updated data to which the user may be entitled but which has not yet been received can be downloaded; and any Friends that are currently on line may be identified. Any off line changes the user has made that are to be shared with Friends may be sent to the Friends that are currently online. Otherwise, if the Friends are not operating online, then any changes may remain in the user's peer terminal for dissemination when the selected Friends and the user are both online. In an alternative embodiment, any changes may be buffered in the special purpose peer and/or the Server for dissemination when the Friend next logs in to the system. When two or more Friends are operating on line and one makes a change to a shared data element, the change made may be automatically propagated to the corresponding Friend in a peer-to-peer fashion, using the application itself, without separate action by the user and without initiation by the special purpose peer and/or server. As detailed below, this facilitates automatic synchronization of shared data elements.

According to another aspect of the invention, the data elements and other information to be shared may be created and/or modified and shared using a single application rather than needing separate applications.

According to another aspect of the invention, the invitation to share information may be extended to selected friends for defined folders, sub-folders, items, and/or other data elements. The selected friends may accept or decline the invitation on a folder-by-folder basis, sub-folder-by-sub-folder basis, item-by-item basis, or other data element basis.

Permissions for modifying the information may be granted to selected friends on a folder-by-folder basis, sub-folder-by-sub-folder basis, item-by-item basis, or other data element basis. Selected friends may be granted, for example, full control, read only access, or blocked access to the defined folders, sub-folders, items, and/or other units of information. Other level of permissions may be used.

An application UI may include various toolbars and various panes or windows that display and enable interaction with various aspects and features of the application. For example, the application UI may include one or more of a Folders pane, a Contacts pane, an Item View pane, a Comments pane and a Messages pane. Other panes may be provided.

The Folders pane enables the user to create, select, manage, view, edit and otherwise interact with folders and items within folders. A selected folder may be designated by highlighting, or otherwise, and the contents (e.g., sub-folders and/or items located therein) of the selected folder may be displayed in the Item View pane described below.

Folders may be created and displayed in a hierarchical format to organize related data elements. Each folder may include associated items that may be created and displayed in the Items View pane.

The Folders toolbar may have several shortcut buttons (or other icons) for performing various operations associated with the folders. For example, the toolbar functions may enable editing, sharing, printing content from the selected folders, creating a new folder, creating a new item for the selected folder, cutting from the selected folders, copying from the selected folders, pasting to the selected folders, searching for specified text within the selected folders, marking the selected folders as read or unread, and renaming the selected folders, deleting the selected folders, among other options.

The Item View pane and/or a Comments pane may display information related to a Selected Folder, item or other data element. The selected folder or other data element may be a folder in the Folders pane, a contact in the Contacts pane or otherwise. For example, the Item View pane may display, for a selected folder, one or more fields such as an item name, creation date, modified by, modified date, owner, and other fields or information.

Item View pane may include one or more toolbar buttons for performing various operations associated with displayed items such as, for example, adding, editing, and/or deleting an item; and enabling a user to control the fields (or columns) of information displayed for each selected folder/item.

When more than one item is displayed for a selected folder, a user may select an item. Information associated with the selected items may be displayed in the Comments pane.

A Messages pane may be provided for enabling communication between Friends. The communications may be implemented via a communications module associated with the software application itself. Users may save communications from the Messages pane. These communications may be stored as data elements (or otherwise). If stored as data elements within the application, they may be stored in folders, shared and otherwise interacted with, as with other data elements described herein.

The invention has numerous advantages over and avoids many drawbacks of prior systems. A single application may be provided to create, modify and/or share data elements. A user may select and invite Friends to share certain data elements or otherwise participate in peer-to-peer communication. The data elements may be shared among Friends according to selectively granted permissions. The data elements may be made available to users through a variety of devices and media, such as for example, blogs, relational databases, cell phones, and other devices and media. Any changes that are made to the data elements may be automatically and/or instantaneously propagated to selected users that have accepted invitations to share the data elements. Additions and/or changes that are made to the data elements may be flagged and/or visually distinguished for easy identification.

These and other objects, features, and advantages of the invention will be apparent through the detailed description of the embodiments and the drawings attached hereto. It is also to be understood that both the foregoing general description and the following detailed description are exemplary and not restrictive of the scope of the invention. Numerous other objects, features, and advantages of the invention should now become apparent upon a reading of the following detailed description when taken in conjunction with the accompanying drawings, a brief description of which is included below.

### BRIEF DESCRIPTION OF THE DRAWINGS

FIG. 1 illustrates an exemplary embodiment of a system diagram according to an embodiment of the present invention.

FIG. 2 illustrates an exemplary screen-shot of the login user interface according to an embodiment of the present invention.

FIG. 3 illustrates an exemplary screen-shot of the application user interface according to an embodiment of the present invention.

FIG. 4 illustrates another exemplary screen-shot of the application user interface according to an embodiment of the present invention.

FIGS. 5A and 5B illustrate a flow chart schematic of the folder-sharing feature according to an embodiment of the present invention.

FIG. 6 illustrates an exemplary screen-shot of the friend selection user interface according to an embodiment of the present invention.

FIG. 7 illustrates a flow chart schematic of the friend-creating feature according to an embodiment of the present invention.

### DETAILED DESCRIPTION OF THE INVENTION

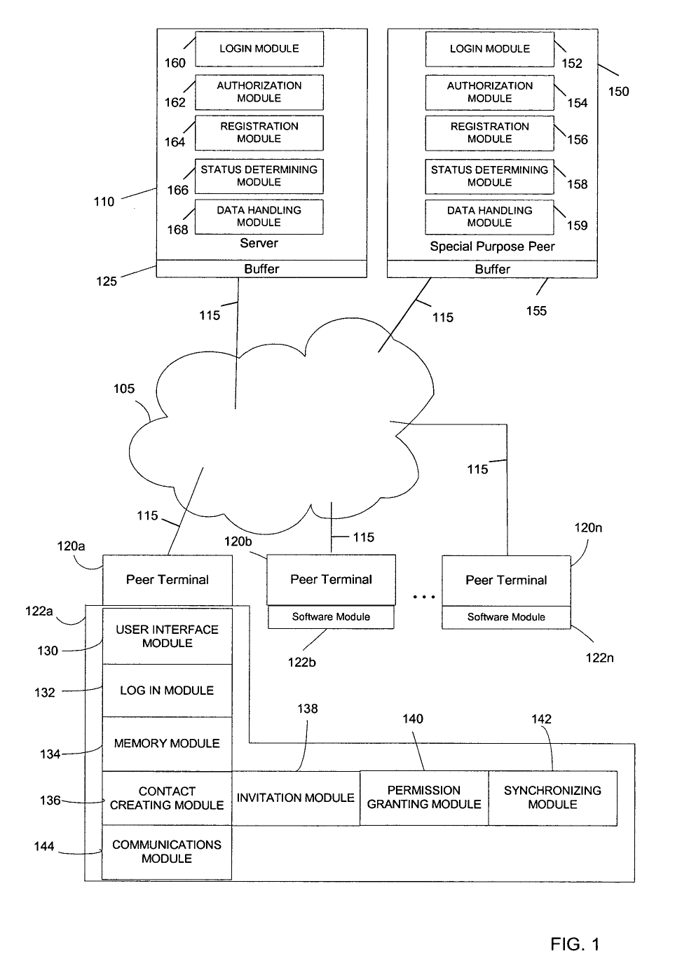

FIG. 1 illustrates an example of the system architecture 100 according to one embodiment of the invention. The peer terminals 120a-120n, special purpose peer(s) 150, and server(s) 110 may be connected via a wired network, a wireless network, a combination of the two and/or other networks (for example the Internet) or other network 105. The system of FIG. 1 is provided for illustrative purposes only and should not be considered a limitation of the invention. Other configurations may be used.

The peer terminals 120a-120n may include any of a number of terminal devices including, for example, personal computers, laptops, PDAS, cell phones, Web TV systems, devices that combine the functionality of one or more of the foregoing or other terminal devices, and various other peer terminal devices capable of performing the functions specified herein.

Communications may be directed from one peer terminal 120a-120n to another peer terminal 120a-120n via a network 105, such as the Internet. Peer terminals 120a-120n may be coupled to each other directly and/or indirectly and may communicate via communication media 115 such as, for example, any wireless and/or wired media.

Communications between respective peer terminals 120a-120n may occur substantially in real-time if both peer terminals 120a-120n are operating online. Otherwise, the communications may be delayed for an amount of time if, for example, one or more peer terminals 120a-120n are not operating online. In one exemplary embodiment, any changes that are made while a peer terminal 120a-120n is operating offline may be propagated from/to the offline peer terminal 120a-120n when both the source and target peer terminal 120a-120n are operating online. Otherwise, in another exemplary embodiment, if one of the source and target peer terminals 120a-120n is not operating online, then any changes may remain in the corresponding peer terminal 120a-120n for dissemination, when the source and target peer terminals 120a-120n are both operating online.

In an alternative embodiment, any changes may be buffered in the server 110 and/or the special purpose peer 150 for dissemination, when the corresponding target peer terminal 120a-120n is operating online. The delay may be implemented using a buffer 125 associated with server 110 and/or a buffer 155 associated with special purpose peer 150. Buffers 125/155 may receive and store information from source peer terminals 120a-120n that is intended for corresponding target peer terminals 120a-120n that may be temporarily disconnected from the network 105. Upon reconnection to the network 105, server 110 and/or special purpose peer 150 may cause information stored in buffer 125/155, respectively, to be forwarded to the corresponding target peer terminals 120a-120n.

The special purpose peer may include one or more of a routing peer, a back-up peer, an authentication peer, a presence peer, a relay peer, and/or other special purpose peers. In an exemplary embodiment, peer terminals 120a-120n may be configured as special purpose peers.

The routing peer may serve as a gateway between peer terminals 120a-120n to provide, for example, indirect communication between two or more peer terminals 120a-120n when a direct connection between peer terminals 120a-120n may not be established.

The back-up peer, for example, may store an identical copy of content associated with a selected peer terminal 120a-120n, may mirror changes made to the selected peer terminal 120a-120n in real-time, and/or may be available to synchronize (e.g., send and/or receive) information with the selected peer terminals 120a-120n.

The authentication peer, for example, may check credentials of users and validate that users are registered users.

The presence peer, for example, may maintain availability information about registered users. The presence peer, for example, also may detect whether registered users are operating online or offline and may detect the type of network connection (e.g., dialup, broadband, direct, gateway, etc.) used to participate in the peer-to-peer communication. In an exemplary embodiment, registered users may access the presence peer to determine a status of selected Friends.

The relay peer, for example, may serve as a gateway between peer terminals 120a-120n and may temporarily store and retrieve selected messages when the target peer terminal 120a-120n is operating offline. In an exemplary embodiment, a first registered user may send an invitation to a second registered user requesting the second registered user to participate in a peer-to-peer communication. If the second registered user is operating offline, then the relay peer may store the invitation until a time when the second registered user logs into the system. After the second registered user logs into the system, the relay peer may retrieve and send the invitation to the second registered user. The relay peer may also temporarily store and retrieve a response sent by the second registered user to the first registered user, if the first registered user is operating offline when the response is sent by the second registered user.

Communications via the network 105 (e.g., the Internet) may be implemented using current and future language conventions and/or current and future communications protocols that are generally accepted and used for generating and/or transmitting messages over the network 105. Language conventions may include, for example, Hypertext Markup Language (“HTML”) and extensible Markup Language (“XML”), etc. Communication protocols may include, for example, Hypertext Transfer Protocol (“HTTP”), TCP/IP, SSL/TLS, FTP, GOPHER, and/or other protocols.

Each peer terminal 120a-120n may include, or be modified to include, a peer side software module 122a-122n. Peer side software module 122a-122n may include one or more of a user interface module 130, a login module 132, a memory module 134, a contact creating module 136, an invitation module 138, a permission granting module 140, a synchronizing module 142, a communication module 144, and other modules, if desired.

The special purpose peer(s) 150 may include, or be modified to include one or more of a special purpose peer side login module 152, an authorization module 154, a registration module 156, a status determining module 158, a data handling module 159, and other modules, if desired. The server(s) 110 may include, or be modified to include one or more of a server side login module 160, an authorization module 162, a registration module 164, a status determining module 166, a data handling module 168, and other modules, if desired.

Peer side software module 122a-122n, special purpose peer side login module 152, and/or server side login module 160 may be of modular construction to facilitate adding, deleting, updating and/or amending modules therein and/or features within modules. It should be readily understood that a greater or lesser number of modules might be used. One skilled in the art will also readily recognize that the invention may be implemented using individual modules, a single module that incorporates the features of two or more separately described modules, individual software programs, and/or a single software program.

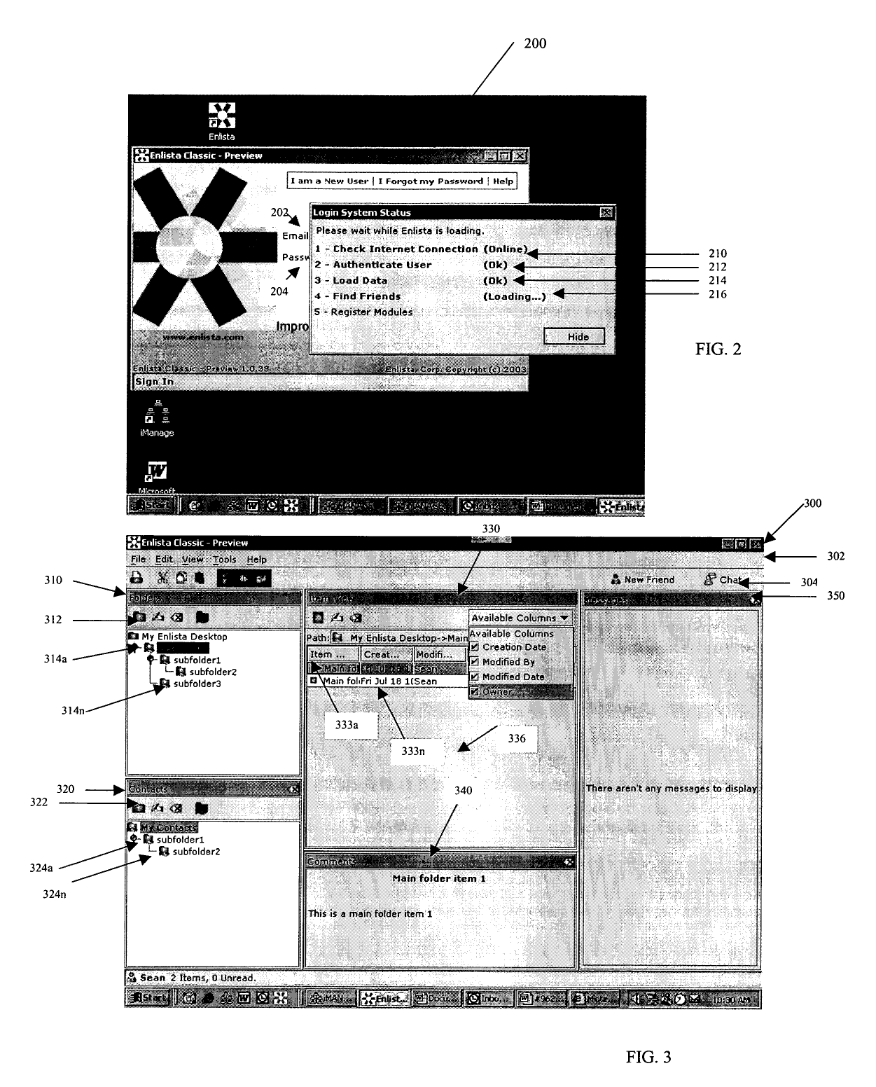

FIG. 2 illustrates an exemplary peer side login user interface (UI) 200 that may be associated with the corresponding peer side software module 122a-12n. Upon launching the application residing on the peer terminal 120a-120n, the peer side login UI may be presented to the user. The peer side login UI 200 may prompt a user to enter access information such as, for example, a user identifier (e.g., an e-mail address) 202 and a password 204. Other information may be required. In some cases, some or all of this information may be stored on the peer terminal 120a-120n (e.g., in a memory module) and may be presented to the user for confirmation. Other user identification techniques may be used.

If the user is operating online, the access information may be forwarded to special purpose peer 150 and/or server 110. The special purpose peer 150 and/or server 110 may perform various functions. In an exemplary embodiment, the special purpose peer side login module 152 may receive access information entered into peer side login UI 200. Authorization module 154 may compare the access information with existing records and operate as a gatekeeper to system 100. If the user is determined to be a registered user, the authorization module 154 may attempt to authenticate the registered user by matching the entered access information with access information that exists in the special purpose peer 150. If the user is not authenticated, then the user may be invited to resubmit the requested registration information or take other action. If the registered user is authenticated, then the special purpose peer 150 may perform other processing. For example, a data handling module 159 on the special purpose peer 150 may load data or other information (e.g., download) to the peer terminal 120a-120n that the registered user may be permitted to access, but has not yet received from the special purpose peer 150 (e.g., data in buffer 155). Furthermore, the peer terminal 120a-120n may directly receive data or other information from another peer terminal 120a-120n that the registered user may be permitted to access, but has not yet received from the other peer terminal 120a-120n.

In another exemplary embodiment, the server side login module 160 may receive access information entered into peer side login UI 200. Authorization module 162 may compare the access information with existing records and operate as a gatekeeper to system 100. If the user is determined to be a registered user, the authorization module 162 may attempt to authenticate the registered user by matching the entered access information with access information that exists in the server 110. If the user is not authenticated, then the user may be invited to resubmit the requested registration information or take other action. If the registered user is authenticated, then the server 110 may perform other processing. For example, a data handling module 168 on the server may load data or other information (e.g., download) to the peer terminal 120a-120n that the registered user may be permitted to access, but has not yet received from the server 110 (e.g., data in buffer 125). Furthermore, the peer terminal 120a-120n may directly receive data or other information from another peer terminal 120a-120n that the registered user may be permitted to access, but has not yet received from the other peer terminal 120a-120n.

The special purpose peer 150 and/or the server 110, for example, may include a status determining module 158 and 166, respectively, which identify Friends of the registered user that are currently operating online. In an exemplary embodiment for the special purpose peer 150, the status determining module 158 may correspond to the presence peer. The status determining module 158/166 may identify a list of Friends associated with the registered user and may determine which, if any, Friends are currently available for peer-to-peer communication. The status determining module 158/166 also may provide an indication of availability for a list of Friends via an application user interface. To facilitate the status providing feature, a log may be created by the special purpose peer 150 and/or the server 110 to maintain a status of registered users that are online at any given time.

A registration module 156/164 may also be provided on the corresponding special purpose peer 150 and/or server 110 to register the various modules that reside in peer terminal 122a-122n. If a new version or features of the application and/or modules are available, the registered user may be prompted to download the new version or features. For example, an alert may be sent to the registered user via e-mail correspondence or other communication indicating that the new version or features are available for download. In response to the alert, the registered user may elect to download the new version or features.

A checklist of these features associated with the peer side login user interface (UI) 200 is illustrated as elements 210-216 in FIG. 2. Not all of these functions need to be performed and other functions may also be performed. The functions need not be performed in the specified order.

If, at login, the user is online and a determination is made that the user has not previously registered (e.g., with the special purpose peer 150, the server 110, or otherwise), then the user may be provided with a registration UI to prompt the user to register. Requested registration information may include, for example, submission of access information, contact information, and/or other registration information. Upon receipt of the registration information, the registration module 156/164 may add the user to a list of registered users.

If, at login, the user is offline, the peer side login module 132 may handle the login request. In an exemplary embodiment, the peer side login UI may be presented to the user. The peer side login UI 200 may prompt the user to enter access information such as, for example, a user identifier (e.g., an e-mail address) 202 and a password 204. Other information may be required. In some cases, some or all of this information may be stored on the peer terminal 120a-120n (e.g., in a memory module) and presented to the user for confirmation. Other user identification techniques may be used.

The peer side login module 132 may process and/or store the access information. If the user is determined to be a registered user, then login module 132 may enable the registered user to access the features of the peer side software application as described below. If the user is determined not to be a registered user, then the user may be invited to resubmit the requested registration information or take other action. After the user enters the registration information, then the registered user may be allowed to access the features of the peer side software application as described below.

Whether the registered user is operating online or offline, the user interface (UI) module 130 is the primary mechanism for interaction between the registered user and the peer side software application. The UI module 130 provides the layout of panes, tools, and other components with which the user interacts with the peer side software application.

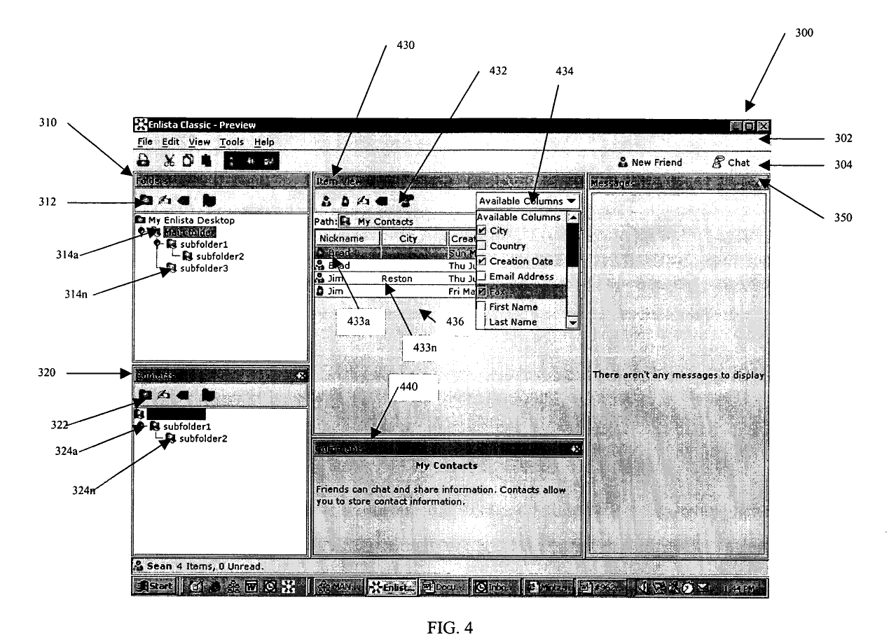

FIG. 3 illustrates an exemplary layout of a peer side application UI 300. Application UI 300 may include toolbars (302,304) and various panes (310,320,330,340,350) that illustrate several aspects and features of the application. According to one embodiment, the application UI 300 may include one or more components, such as various panes and/or toolbars. For example, the application UI 300 may include one or more of a Folders pane 310, a Contacts pane 320, an Item View pane 330, a Comments pane 340 and a Messages pane 350. Other panes may be provided.

Folders pane 310 enables the registered user to select folders 314a-314n that are illustrated therein. A selected folder may be designated by highlighting or some other distinguishing feature. The contents (e.g., sub-folders and/or items located therein) of the selected folder may be displayed in the Item View pane 330 and/or Comments pane 340.

In an exemplary embodiment, toolbar 302 may include various pull down menus that enable several operations to be performed by the application. For example, toolbar 302 may include pull down menus related to File, Edit, View, Tools and Help operations. Furthermore, toolbar 304 may include several shortcut buttons for performing various operations such as, for example, printing, cutting, copying, and/or pasting of information. Toolbar 304 may also include several buttons that enable the registered user to control, for example, a display of various panes (310,320,330,340,350) associated with the application and/or that enable the registered user to initiate modules associated with, for example, creating new friends, invoking chat, among other features.

Folders may be created and displayed in a hierarchical format as illustrated in Folders pane 310 and Contacts pane 320 to organize related data elements. Each folder may include associated items that may be created and stored in Items View pane 330. Additionally, subfolders may be created from and may be associated with a parent folder to further define characteristics of the parent folder. The parent folders and the subfolders may each include respective items defined by the registered user.

Folders pane 310 may include a toolbar 312 and a graphical display of a hierarchical folder structure. The toolbar 312 may have several shortcut buttons (or other icons) for performing various operations associated with the folders 314a-314n. For example, the toolbar functions may enable adding folders, editing folders, deleting folders, sharing folders, and/or other operations. Registered users may also interact with the displayed folder structure to select additional options related to the folders. The additional options may include, for example, editing, sharing, printing content from the selected folders, creating a new folder, creating a new item for the selected folder, cutting from the selected folders, copying from the selected folders, pasting to the selected folders, searching for specified text within the selected folders, marking the selected folders as read or unread, and renaming the selected folders, deleting the selected folders, and/or other options.

Item View pane 330 and/or Comments pane 340 may be displayed in the software application to provide registered users with additional information relating to Folders pane 310 or Contacts pane 320. FIG. 3 illustrates an embodiment where Folders pane 310 is highlighted and Item View pane 330 and Comments pane 340 both display information corresponding to Folders pane 310.

In an exemplary embodiment, Item View pane 330 may display content associated with a folder selected from the Folders pane 310. Item View pane 330 may include one or more toolbars 332 having several shortcut buttons (or icons) for performing various operations associated with selected folders such as, for example, adding, editing, deleting an item, and/or other operations. Toolbar 332 may also include an Available Columns drop down menu (or other tool) 334 to enable a user to control the columns of information displayed for items 333a-333n. For example, the Item View pane 330 may illustrate one or more fields such as an item name, creation date, modified by, modified date, owner, and/or other fields or information. The selected columns may be displayed in a body 336 of Item View pane 330. Furthermore, the items 333a-333n may be organized and/or searched according to the options in the selected columns

A registered user may select an item 333a-333n. For the selected item, the contents may be illustrated in Comments pane 340. Options may be provided to manipulate the items 333a-333n and may include, for example, editing content from the selected item 333a-333n, creating a new folder, creating a new item, cutting content from the selected item 333a-333n, copying content from the selected item 333a-333n, pasting content to the selected item 333a-333n, marking the selected item 333a-333n as unread, deleting the selected item 333a-333n, and/or other options. In another exemplary embodiment, Comments pane 340 may be provided to display comments associated with corresponding items 333a-333n and/or other content associated with selected item 333a-333n.

Messages pane 350 may be provided for enabling communication between registered users, such as exchanging information. The communications may be implemented via e-mail, chat, instant messaging (IM), or other communication techniques. Registered users may save communications from the Messages pane 350. In one exemplary embodiment, the communications may be saved as items. These items may be stored in folders within the Folders pane 310 and/or the Contacts pane 320 and may be associated with corresponding folders. This feature facilitates collaboration through organizing the information and/or sharing the information with the one or more Friends.

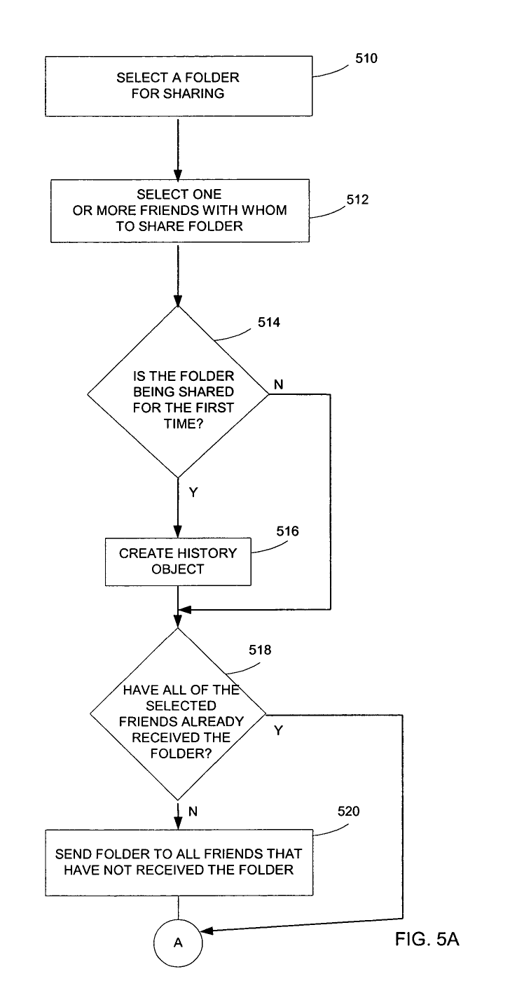

FIG. 4 illustrates another exemplary embodiment of the peer side application UI 300. Contacts pane 320 enables the registered user to select folders 324a-324n therein. A selected folder 324a-324n may be designated by highlighting or some other distinguishing feature. The contents (e.g., sub-folders and/or items located therein) of the selected folder may be displayed in the Item View pane 430 and/or Comments pane 440.

In an exemplary embodiment, the folders in Contact pane 320 may include data elements or items 433a-433n configured as a Contact and/or a Friend. Items 433a-433n may include contact information or other information associated with persons or entities about whom information is known and stored. For example, items 433a-433n may be defined by contact information that may be segmented based on categories of information. A first category may include, for example, main information such as a nickname, an e-mail address, a first name, a last name, comments, and other main information. A second category may include personal information such as a street addresses, a phone numbers, a facsimile number, a mobile number, a pager number, and other personal information. A folder of Contacts and/or Friends may include a group of related Contacts and/or Friends.

Contacts pane 320 may include a toolbar 322 and a graphical display of a hierarchical folder structure. Toolbar 322 may include several shortcut buttons (or other icons) for performing various operations on folders 324a-324n. For example, the toolbar functions may enable adding folders, editing folders, deleting folders, sharing folders, and/or other operations. Registered users may interact with the displayed folder structure to select additional options related to the folders. The additional options may include, for example, editing the selected folders, sharing the selected folders, printing content from the selected folders, creating a new folder, creating a new contact for the selected folder, creating a new friend for the selected folder, cutting content from the selected folder, copying content from the selected folder, pasting content to the selected folder, searching for specified text within the selected folder, marking the selected folders as read or unread, renaming the selected folders, deleting the selected folders, and/or other options.

Item View pane 430 and/or Comments pane 440 may be displayed in the software application to provide registered users with additional information relating to Contacts pane 320. FIG. 4 illustrates an embodiment where Contacts pane 320 is highlighted and Item View pane 430 and Comments pane 440 both may display information corresponding to Contacts pane 320.

In an exemplary embodiment, Item View pane 430 may display content associated with a folder selected from Contacts pane 320. Item View pane 430 may include one or more toolbars 432 having several shortcut buttons (or icons) for performing various operations associated with selected folders such as, for example, creating a new friend, creating a new contact, editing an item, deleting the item, initiating chat, and/or other operations. Toolbar 432 may also include an Available Columns drop down menu (or other tool) 434 to enable a user to control the columns of information displayed for items 433a-433n. For example, the Items View pane 430 may illustrate one or more fields such as an item name, city, country, creation date, e-mail address, fax, first name, last name, and/or other fields or information. The selected columns may be displayed in a body 436 of Item View pane 430. Furthermore, the items 433a-433n may be organized and/or searched according to the options in the selected columns.

A registered user may select an item 433a-433n. For the selected item, the contents may be illustrated in Comments pane 440. Options may be provided to manipulate item 433a-433n and may include, for example, editing content from the selected item 433a-433n, initiating chat with selected friends, adding selected friends to a conversation, creating a new folder, creating a new contact, creating a new friend, cutting content from the selected item 433a-433n, copying content from the selected item 433a-433n, pasting content to the selected item 433a-433n, marking the selected item 433a-433n as unread, renaming the selected item 433a-433n, deleting the selected item 433a-433n, and/or other options. In another exemplary embodiment, Comments pane 440 may be provided to display comments associated with corresponding items 433a-433n and/or other content associated with selected item 333a-333n.

In an exemplary embodiment, Contacts may be designated as sharing contacts, or Friends, by enabling a sharing feature associated with the Contact. The sharing feature allows Friends to view selected data elements and/or to modify the selected data elements based on permissions granted by the data element owner.

In an exemplary embodiment, the data element owner may enable a Friend to grant permissions to another Friend for sharing the data elements, wherein the other Friend may or may not be a Friend of the data element owner. This may occur when the data element owner grants “right to share” privileges in “X degrees” to the Friend. For example, the data element owner may enable a first Friend to share the data element in a first degree. In this case, the first Friend may be allowed to share the data element with a second Friend, which may not be a Friend of the data element owner. Since the sharing is enabled pursuant to a first degree, the second Friend would not be able to share the data element with anyone else. In a case where the sharing degree equals two, the second Friend would be able to share the data element once with a third Friend, wherein the third Friend may not be a Friend of the owner or the first Friend. A sharing degree of zero would not allow a first Friend to share the data element with anybody. Other numbers of sharing degrees may be granted.

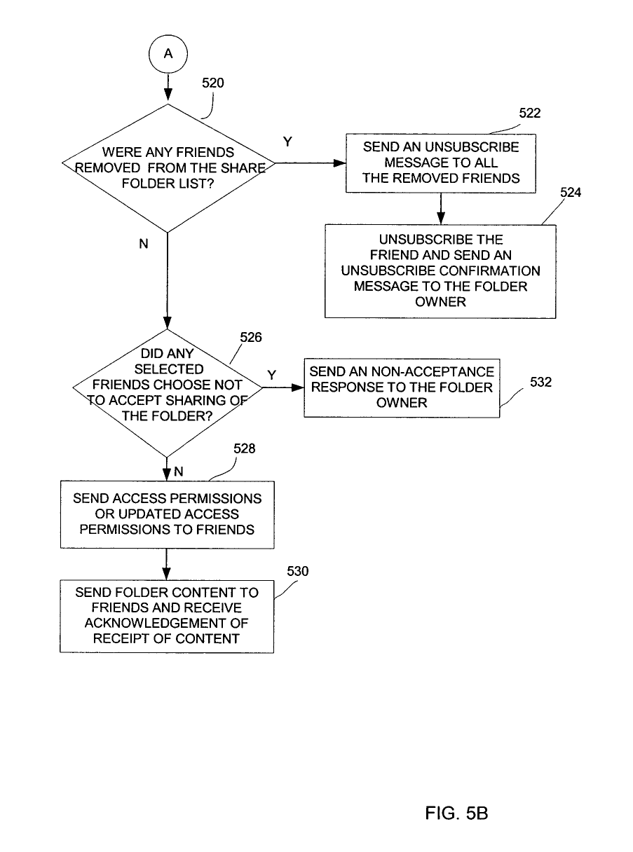

FIGS. 5A and 5B illustrate a flow diagram of a generalized method for implementing the folder sharing feature. In operation 510, the folder owner may select folders to share. The folder owner may initiate the share folder feature using a menu item, toolbar button, a shortcut key, or other selector. In operation 512, the folder owner may select one or more Friends to share the folder contents. In operation 514, a determination may be made regarding whether or not the selected folder is being shared for a first time. If the selected folder is being shared for the first time, a history object may be created and associated with the selected folder in operation 516, to enable tracking of changes to the selected folder.

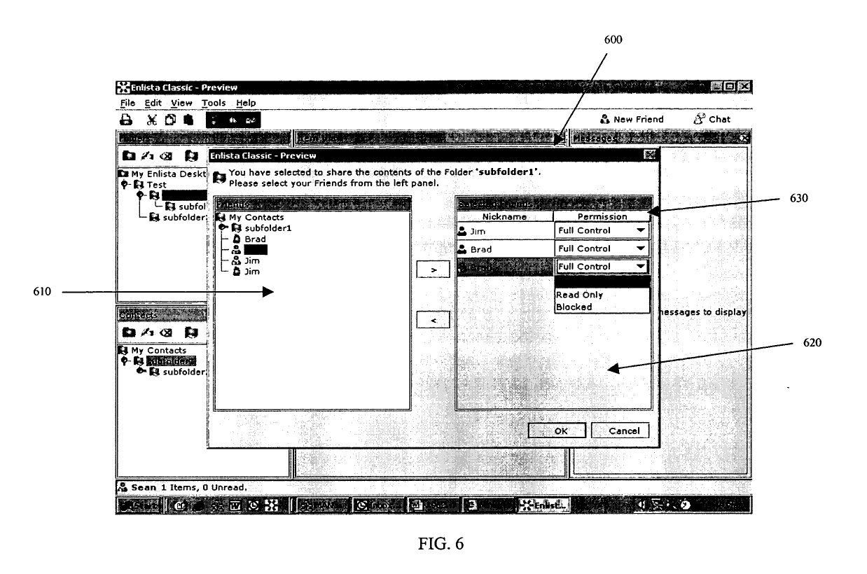

In an exemplary embodiment, invoking the share folder feature may cause a dialog box 600 to appear on the display as illustrated in FIG. 6. The dialog box 600 includes a listing of friends' box 610. The folder owner may select the names of one or more Friends with which to share folders and place the names in selected friends box 620. When the one or more Friends are selected, the folder owner may grant access permissions 630 to each of the one or more selected Friends. The access permissions 630 may include options such as, for example, full control, read only status, or blocked status. In an exemplary embodiment, only the folder owner may be granted rights to permanently delete the folder. In an exemplary embodiment, the application may compile and distribute identifying information regarding the one or more selected Friends to each of the one or more selected Friends.

In operation 520, the folder owner may send an invitation to all Friends inviting them to share the content of the selected folder or to all Friends that are selected to share the folder, but have not previously received and declined the invitation to share the folder.

In an exemplary embodiment, the authentication peer may receive the invitation that is intended for the selected Friends. The authentication peer may determine whether the selected Friends are registered users. Furthermore, the presence peer may determine whether the selected Friends are operating online or offline. If the selected Friends are validated and determined to be operating online, then the invitation may be forwarded to the peer terminals 120a-120n associated with the selected Friends. If the selected Friends are validated, but determined to be operating offline, then the invitation may be forwarded to the relay peer for processing when the selected Friends log in to the system.

If a determination is made that the selected Friends have not previously registered, the selected Friends may not be validated and may be prompted to register with the special purpose peer 150, the server 110, or otherwise. The selected Friends may be provided with a registration UI to facilitate registration. Requested registration information may include, for example, submission of access information, contact information, and other registration information. Upon receipt of the registration information, the registration module 156/164 may add the selected Friends to a list of registered users.

In operation 522, a determination may be made regarding whether any Friends were removed from the list of Friends previously selected to share the folder contents. In operation 524, the removed Friends may be informed of their removal via an unsubscribe message. In operation 526, the subscription privileges may be revoked from selected Friends. If the unsubscribe feature is selected, then the corresponding one or more selected Friends may cease to receive further correspondence related to the selected folders and the folder owner may receive an unsubscribe acknowledgment message. Furthermore, if the selected folder already existed in the application of the respective one or more selected Friends, then the selected folder may be removed. The folder owner may receive a message acknowledging removal of the selected folder.

Alternatively, in operation 530, the one or more selected Friends may choose whether or not to accept the invitation to share the contents of a folder. If the Friend declines to share the contents of a folder, then the folder owner may be informed of the non-acceptance via a non-acceptance response received from the Friend. If the one or more selected Friends choose to accept the invitation to share the folder contents, then the Friends may be provided with an indication of the permission that has been granted to them by the folder owner in operation 534. The permissions granted to the one or more selected Friends for the selected folders may be changed at any time by the folder owner. When the changes to the granted permissions are implemented, the folder owner may receive an acknowledgment message confirming the change. When sharing nested sub-folders with the one or more selected friends, the subfolders may automatically receive a same permission that is granted to parent folders. Alternatively, the subfolders may receive different permissions than are granted to parent folders. Furthermore, the same permissions may be granted simultaneously to a group of selected Friends.

In an exemplary embodiment, a determination may be made regarding whether or not the selected folders have been previously shared with the one or more selected Friends. If a determination is made that the selected folders are being shared with the one or more selected Friends for a first time, then the selected folder may be added to a root folder in the corresponding folders window 310 or contacts window 320, for example. The content of the selected folder may be forwarded to the corresponding root folder of the one ore more selected Friend's application and acknowledgement of receipt may be returned to the folder owner in operation 536.

If a determination is made that the selected folders are being shared other than the first time, then only modifications to the content of the selected folder may be forwarded to the corresponding folders of the one or more selected Friends. Information regarding the existence of selected folders in the root directory of the one or more selected Friends' application may be provided during the initial exchange between the peer terminals 120a-120n.

In addition to enabling folder owners to share selected folders with one or more selected Friends, folder owners may also elect to revoke sharing privileges from the one or more selected Friends. In a case where all of the Friends are removed from the list of selected Friends, the history object of the associated folder may be cleared.

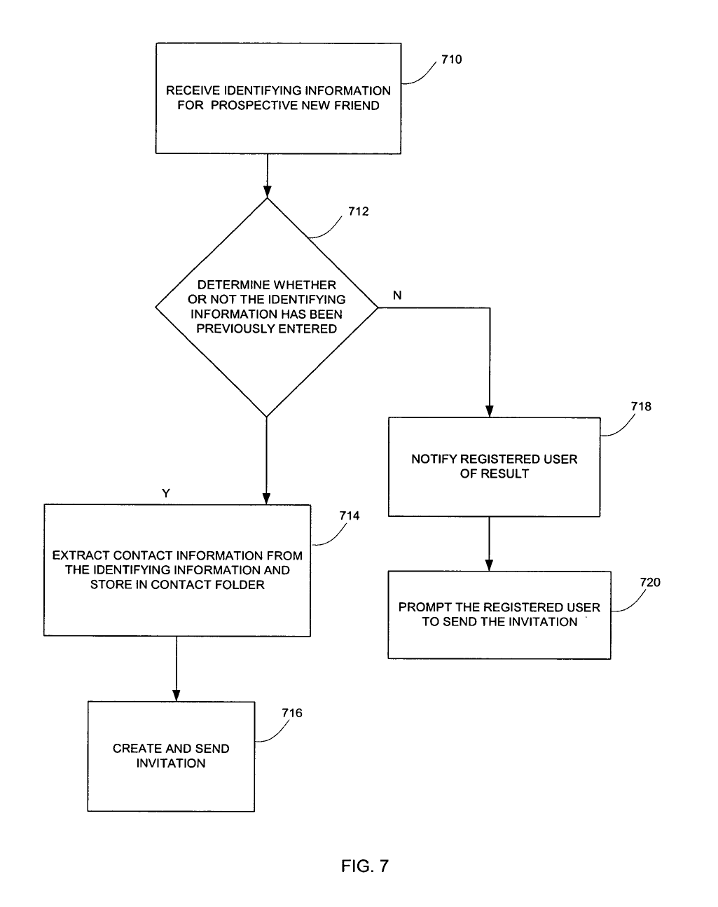

FIG. 7 illustrates a flow diagram of a generalized method for adding new Friends that may be invited to participate in interactive activities. In operation 710, identifying information may be entered for prospective Friends. In operation 712, a determination may be made regarding whether or not the identifying information for the prospective Friends has been previously entered into the system. For example, the special purpose peer 150 and/or the server 110 may compare the e-mail address provided for the prospective Friends against e-mail addresses stored in the special purpose peer 150 and/or the server 110.

If the e-mail address for the prospective Friends is determined to already exist in special purpose peer 150 and/or server 110, then, in operation 714, contact information may be extracted from the associated identifying information and stored in a corresponding contact folder for the prospective Friend. In operation 716, an invitation may be created and sent to the prospective Friend, wherein the invitation may include, for example, information regarding the registered user's Internet Protocol Address and additional protocol to enable establishing a peer-to-peer connection.

If the e-mail address of the prospective Friend is determined not to exist in special purpose peer 150 and/or server 110, then the registered user may be notified of this result in operation 718. The registered user also may be prompted in operation 720 to send an invitation to the prospective Friend via e-mail, for example.

If the registered user decides to send an invitation to the prospective Friends, then an e-mail template may be provided to the registered user requesting additional information and/or comments, for example. The registered user may elect to send the invitation to the prospective Friend now or to postpone sending the invitation until a later date. In either case, contact information may be extracted from the associated identifying information and stored in a corresponding contact folder for the prospective Friends. The application may create and send an invitation to the prospective Friends that includes, for example, information regarding the registered user's Internet Protocol (IP) Address and additional protocol to enable establishing a peer-to-peer communication.

If the registered user decides not to send an invitation to the prospective Friend, then contact information may be extracted from the associated identifying information and stored in a corresponding contact folder for the prospective Friend.

In an exemplary embodiment, the authentication peer may receive the invitation that is intended for the prospective Friend. The authentication peer may determine whether the prospective Friend is a registered user. Furthermore, the presence peer may determine whether the prospective Friend is operating online or offline. If the prospective Friend is validated and determined to be operating online, then the invitation to share information may be forwarded to the peer terminals 120a-120n associated with the prospective Friend. If the prospective Friends is validated, but determined to be operating offline, then the invitation to share information may be forwarded to the relay peer for processing when the prospective Friends log in to the system.

If a determination is made that the prospective Friend has not previously registered, the prospective Friend may not be validated and may be prompted to register with the special purpose peer 150, the server 110, or otherwise. The prospective Friend may be provided with a registration UI to facilitate registration. Requested registration information may include, for example, submission of access information, contact information, and other registration information. Upon receipt of the registration information, the registration module 156/164 may add the prospective Friends to a list of registered users.

The invitation may be configured to include the registered user's IP Address and additional protocol, for example, to enable the prospective Friends to establish peer-to-peer communication.

If the prospective Friend accepts the invitation, then an acceptance message may be returned to the registered user. The prospective Friend may become a Friend of the registered user. Additionally, the system 100 may monitor for the acceptance message and disable sending the invitation the Friend again. Furthermore, a contact folder may be created in the application of respective Friends. The contact folder may include identifying information of the registered user. The Friends also may review and update their identifying information, which is received from the registered user. Any changes to the identifying information may be automatically disseminated to the registered user and all associated Friends.

If the prospective Friend declines the invitation, then the system 100 may delete the invitation. Furthermore, no additional information may be shared between the registered user and the prospective Friends.

The invitation module 138 may be provided to enable the registered user associated with a client terminal 120a-120n to invite Friends associated with other client terminals 120a-120n to participate in sharing and/or exchanging data elements.

The synchronizing module 142 may be configured to propagate changes to information made within the corresponding client terminals 120a-120n to all, or a selected number, of the other client terminals 120a-120n that are associated with registered users and that have accepted invitations to share the information. The synchronizing module 142 also may be configured to receive changes to information implemented by other registered users associated with corresponding client terminals 120a-120n that have accepted invitations to share the information. In an exemplary embodiment, the synchronizing module 142 may be configured to exchange and/or share information between client terminals 120a-120n in real-time, upon login, or after a specified delay. The synchronizing module 142 may be configured to only provide the most recent changes to data elements, to send and/or receive the contents of entire folders, items, etc., when the folder is created/shared for a first time, to sent the last state of modified folders, items, etc. when the changes are incremental, to request data elements from a random client terminal 120a-120n, when necessary, to request an acknowledge indication for changes sent to other client terminals 120a-120n, to re-send changes until the acknowledge indication is received from the other client terminals 120a-120n, and to identify changes made to the information by other registered users associated with the corresponding client terminals 120a-120n as “new” until reviewed.

In another embodiment, privileges for sharing information may be granted through a common friend when users wishing to share information are not themselves friends. To implement this feature, the common friend and a first and second registered users must all be on-line. Information may be passed from the first registered user to the common friend and forwarded from the common friend to the second registered user.

In an exemplary embodiment, the client terminals 120a-120n may be implemented using personal computers, personal digital assistants, cell phones, video game consoles, kiosks, etc., or combinations thereof. Furthermore, a select function may be implemented by positioning an indicator over selected folders and manipulating an input device, such as a keyboard, mouse, track ball, joystick, etc., to select additional options related to the folders.

While the preferred forms of the invention have been disclosed, it will be apparent to those skilled in the art that various changes and modifications may be made that will achieve some of the advantages of the invention without departing from the spirit and scope of the invention. It will be apparent to those reasonably skilled in the art that other components performing the same function may be suitably substituted. Further, the methods of the invention may be achieved in either all software implementations, using the appropriate processor instructions, or in hybrid implementations that utilize a combination of hardware logic and software logic to achieve the same results. Therefore, the scope of the invention is to be determined solely by the appended claims.

1. A peer-to-peer communication system, comprising:
at least two peer terminals, each having an application that enables peer terminal users to perform at least one of creating data elements, modifying data elements, and sharing data elements, the application comprising:
a contact creating module that enables the peer terminal users to create contacts, wherein at least one contact is associated with another peer terminal user and wherein the at least one contact is designated as a sharing contact for sharing the data elements;
a permission granting module that enables data element owners to selectively grant permissions to selected sharing contacts, wherein the granted permissions provide predetermined rights to specified data elements; and
a synchronizing module that enables instantaneous propagation of changes made to data elements.

2. The system according to claim 1, wherein the application further comprises an invitation module that enables the peer terminal users to invite selected sharing contacts to participate in a communication.

3. The system according to claim 2, wherein the invitation module informs the corresponding peer terminal users whether or not the selected sharing contacts agreed to participate in the communication.

4. The system according to claim 1, wherein the application further comprises a communications module that enables the peer terminal users to communicate with sharing contacts.

5. The system according to claim 1, further comprising at least one special purpose peer.

6. The system according to claim 5, wherein the at least one special purpose peer comprises at least one of a routing peer, a back-up peer, an authentication peer, a presence peer, and a relay peer.

7. The system according to claim 1, wherein the data elements include other data elements.

8. The system according to claim 1, wherein the data elements include at least one of folders, items stored in folders and folder hierarchy.

9. The system according to claim 1, wherein the data elements are structured in a hierarchical format.

10. The system according to claim 1, wherein the permission granting module further enables the data element owners to extend permissions to the sharing contacts to enable the sharing contacts to share the data elements with other peer terminal users.

11. A peer-to-peer communication system, comprising:
at least one special purpose peer; and
at least two peer terminals, each having an application that enables peer terminal users to perform at least one of creating data elements, modifying data elements, and sharing data elements, the application comprising:
a contact creating module that enables the peer terminal users to create contacts, wherein at least one contact is associated with another peer terminal user and wherein the at least one contact is designated as a sharing contact for sharing the data elements;
a permission granting module that enables data element owners to selectively grant permissions to selected sharing contacts, wherein the granted permissions provide predetermined rights to specified data elements;
a synchronizing module that enables instantaneous propagation of changes made to data elements.

12. The system according to claim 11, wherein the at least one special purpose peer comprises at least one of a routing peer, a back-up peer, an authentication peer, a presence peer, and a relay peer.

13. A peer-to-peer communication system, comprising:
at least two peer terminals, each having an application that enables peer terminal users to perform at least one of creating data elements, modifying data elements, and sharing data elements, the application comprising:
contact creating means for enabling the peer terminal users to create contacts, wherein at least one contact is associated with another peer terminal user and wherein the at least one contact is designated as a sharing contact for sharing the data elements;
permission granting means for enabling data element owners to selectively grant permissions to selected sharing contacts, wherein the granted permissions provide predetermined rights to specified data elements; and
synchronizing means for enabling instantaneous propagation of changes made to data elements.

14. The system according to claim 13, wherein the application further comprises invitation means for enabling the peer terminal users to invite selected sharing contacts to participate in a communication.

15. The system according to claim 14, wherein the invitation means informs the corresponding peer terminal users whether or not the selected sharing contacts agreed to participate in the communication.

16. The system according to claim 13, wherein the application further comprises communications means for enabling the peer terminal users to communicate with sharing contacts.

17. The system according to claim 13, further comprising at least one special purpose peer.

18. The system according to claim 17, wherein the at least one special purpose peer comprises at least one of a routing peer, a back-up peer, an authentication peer, a presence peer, and a relay peer.

19. The system according to claim 13, wherein the data elements include other data elements.

20. The system according to claim 13, wherein the data elements include at least one of folders, items stored in folders and folder hierarchy.

21. The system according to claim 13, wherein the data elements are structured in a hierarchical format.

22. The system according to claim 13, wherein the permission granting means further enable the data element owners to extend permissions to the sharing contacts for enabling the sharing contacts to share the data elements with other peer terminal users.

23. A method of communicating in a peer-to-peer environment having at least two peer terminals, wherein each peer terminal includes an application that enables peer terminal users to perform at least one of creating data elements, modifying data elements, and sharing data elements, the method comprising:
enabling the peer terminal users to create contacts, wherein at least one contact is associated with another peer terminal user and wherein the at least one contact is designated as a sharing contact for sharing the data elements;
enabling data element owners to selectively grant permissions to selected sharing contacts, wherein the granted permissions provide predetermined rights to specified data elements; and
enabling instantaneous propagation of changes made to data elements.

24. The method according to claim 23, further comprising enabling the peer terminal users to invite selected sharing contacts to participate in a communication.

25. The method according to claim 24, further comprising informing the corresponding peer terminal users whether or not the selected sharing contacts agreed to participate in the communication.

26. The method according to claim 23, wherein enabling data element owners to selectively grant permissions to selected sharing contacts further comprises enabling the data element owners to extend permissions to the sharing contacts to enable the sharing contacts to share the data elements with other peer terminal users.

27. A computer usable medium having computer readable program code embodied therein for causing a computer to communicate in a peer-to-peer environment having at least two peer terminals, wherein each peer terminal includes an application that enables peer terminal users to perform at least one of creating data elements, modifying data elements, and sharing data elements, comprising:
computer readable program code for causing a computer to enable the peer terminal users to create contacts, wherein at least one contact is associated with another peer terminal user and wherein the at least one contact is designated as a sharing contact for sharing the data elements;
computer readable program code for causing the computer to enable data element owners to selectively grant permissions to selected sharing contacts, wherein the granted permissions provide predetermined rights to specified data elements; and
computer readable program code for causing the computer to enable instantaneous propagation of changes made to data elements.

28. The computer usable medium according to claim 27, further comprising computer readable program code for causing the computer to enable the peer terminal users to invite selected sharing contacts to participate in a communication.

29. The computer usable medium according to claim 28, further comprising computer readable program code for causing the computer to inform the corresponding peer terminal users whether or not the selected sharing contacts agreed to participate in the communication.

30. The computer usable medium according to claim 27, wherein enabling data element owners to selectively grant permissions to selected sharing contacts further comprises enabling the data element owners to extend permissions to the sharing contacts to enable the sharing contacts to share the data elements with other peer terminal users.
